(19) United States
(12) Patent Application Publication
(10) Pub. No.: US 2009/0095793 A1
(43) Pub. Date: Apr. 16, 2009

(54) SELECTIVE SOLDERING APPARATUS WITH MULTIPLE PUMPS AND THIMBLE PLATE AND NITROGEN COOLED PUMP BEARING ASSEMBLY

(76) Inventors: Michael Tombs, Essex (GB); Darren Harvey, Essex (GB)

Correspondence Address: DICKSTEIN SHAPIRO LLP, 1825 EYE STREET NW, Washington, DC, 20006-5403, US

(21) Appl. No.: 11/569,584

(22) PCT Filed: May 25, 2005
(86) PCT No.: PCT/GB2005/002072

§ 371 Date: Nov. 24, 2007

(30) Foreign Application Priority Data
May 25, 2004 (GB) 0411666.1

(51) Int. Cl. B23K 3/06

(52) U.S. Cl. 228/56.1

(57) ABSTRACT

A soldering apparatus comprises a solder bath, a body positioned in the bath and having a plurality of main conduits for feeding solder from a solder pump to a nozzle or thimble. Each conduit communicates with a pump chamber and a conduit in a thimble plate on which the thimbles are mounted. The thimble plate is readily replaced by lifting the main body clear of the solder on lifting mechanisms. Thimbles can be positioned at any desired location on the plate, conduits being formed in the plate to lead from the outlet of a respective conduit.

The present invention relates to selective soldering apparatus and in particular to the pump arrangements in such apparatus. In such apparatus molten solder is pumped from a solder bath into a thimble or nozzle which is supported above the solder in the bath. The pump is regulated to maintain a stationary solder surface at the thimble outlet, or a continuous but stable flow of solder through the thimble outlet, during the soldering operation.

Typically the items to be soldered are leads projecting from an underside of a printed circuit board. The leads extend only a short way from the board and it is necessary to maintain a substantially constant height of the solder surface, at the thimble outlet, during the soldering operation to ensure that the leads are dipped or otherwise immersed into the solder surface to a required, reproducible extent. The solder may be held stationary at the thimble outlet during soldering or it may be flowed over the lip of the thimble as well known in the art.

The height of the solder surface can be monitored optically shortly before the leads are dipped and the pump speed adjusted to bring the solder surface to the required height.

A thimble may be coupled directly to a dedicated pump, which provides for simple control of the solder height. In many applications more than one thimble is required. These may be mounted on a common plate to form a thimble plate and connected to a common pump, for example the thimble plate forms a cover for a chamber and solder is pumped into the chamber and so to the thimbles. A problem with such multi-thimble arrangements is that it is difficult to control simultaneously the height of the solder in all of the thimbles because of the different distances of thimbles from the pump and different sizes of the thimbles. Thus, it is known to provide a multi-pump arrangement in which a plurality of pumps feed respective thimbles or thimble plates.

Often, a selective soldering apparatus is tailored to the board which is being soldered. Thus, each board type requires a dedicated arrangement of nozzles. With known arrangements, particularly multi-pump arrangements, there is considerable machine down-time while the thimble plate is changed to suit a different board production run.

It is an aim of the present invention to provide a pump assembly which facilitates control of the solder surface height at the thimble outlet and which simplifies the procedure for changing the thimble plate.

One aspect of the present invention provides a selective soldering apparatus comprising a solder bath, a body positioned in the bath and having a plurality of main conduits, each main conduit having a first, inlet end for fluid communication with a pump chamber and a second, outlet end which is open at an upper surface of the main body, a thimble plate having upper and lower surfaces, and a plurality of thimble plate conduits in the thimble plate, each thimble plate conduit having a first, inlet end which is open at a lower surface of the thimble plate for fluid communication with the outlet of a respective main conduit and a second, outlet end which is in fluid communication with a thimble.

The main conduits are fed with solder from respective pump chambers and in turn feed the solder to respective thimble plate conduits in the thimble plate. Each thimble plate conduit feeds a respective thimble or group of thimbles. When a different design of board is to be soldered, it is necessary only to change the thimble plate. The solder level at a thimble on each thimble plate conduit can be monitored and the respective pump feeding solder to the thimble plate conduit, via the respective main conduit, can be adjusted as necessary.

Preferably the pump chambers are integral with the main body. An impeller or other pump arrangement may be housed in the chamber.

Preferably the main body is vertically moveable to raise the upper surface of the main body clear of the solder in the bath.

The conduits in the thimble plate may be formed by channels in the plate lower surface, the channels being closed by the main body upper surface.

A seal may be provided at the main conduit outlet to form a seal with the thimble plate conduit inlet.

The thimble conduits can thus be in the form of tracks which extend laterally through the thimble plate from the respective main body conduit outlet to the required location of the thimble on the thimble plate.

Subject to the spacing of the thimbles, it will typically be possible to feed each thimble from a dedicated pump, although we also envisage the possibility of supplying two or more thimbles from a common pump.

Preferably the main body has numerous main conduits and pump chambers, but it is not necessary to provide a pump at each chamber. The number of conduits and pump chambers which need to be utilised, and so fed with pumped solder, will depend on the number of thimbles which are likely to be required

We use an impeller type pump in which the impeller is driven by a shaft extending upwards through the molten solder in the solder bath. The positioning of the shaft bearings closely above the solder surface means that they are subject to considerable heat. Thus another aspect of the invention is to provide a flow of nitrogen gas into the outer housing for the pump bearings. In another aspect of the invention we provide a hollow shaft through which the nitrogen gas can be flowed.

In a further aspect of the invention we also provide a stationary seal around the impeller shaft where it penetrates the solder surface, to eliminate shear between the rotating shaft and the solder surface and avoid the accumulation of solder dust at this region.

The invention will be further described by way of example only, with reference to the accompanying drawings in which:

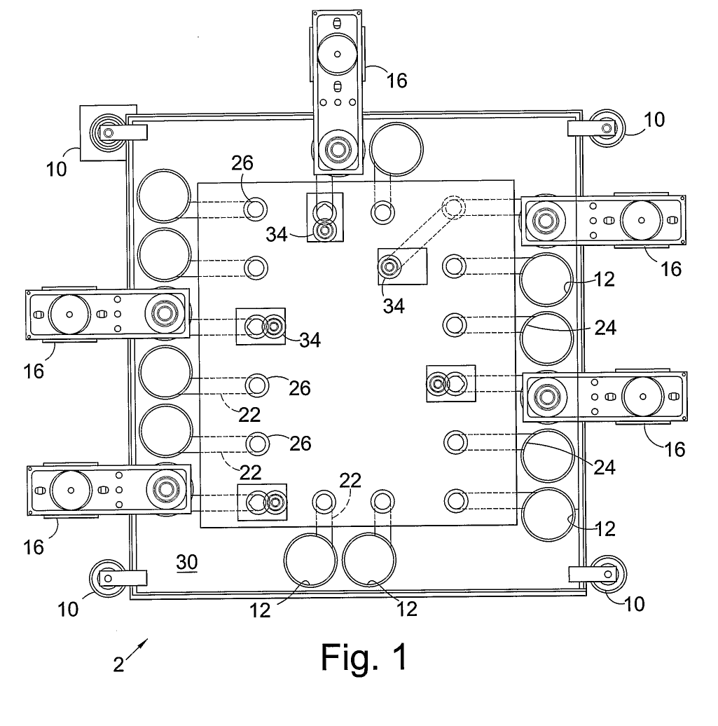

FIG. 1 is a plan view of a soldering apparatus forming an embodiment of the invention,

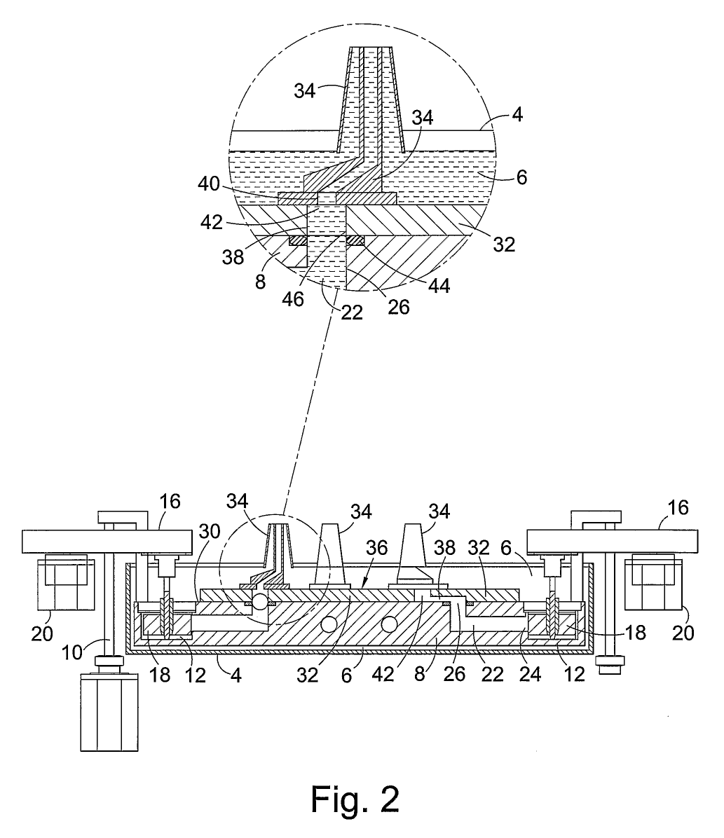

FIG. 2 is a part cross-section view on line II-II of FIG. 2;

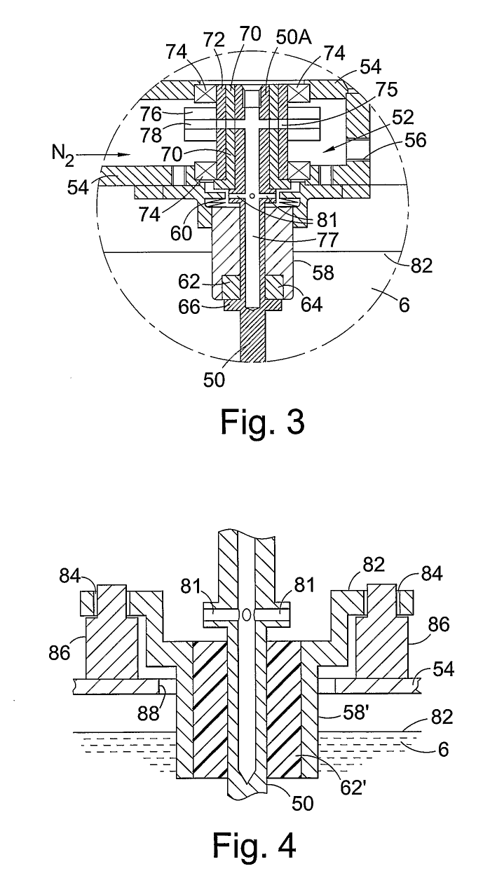

FIG. 3 is a cross-section through a pump bearing assembly forming an embodiment of the invention;

FIG. 4 is an enlarged view of a modification of the embodiment of FIG. 3.

Referring to FIGS. 1 and 2, a selective soldering apparatus 2 has a solder bath 4 which is filled with molten solder 6. Solder 6 is heated by a heater, not shown. A main body 8 is immersed in the solder 6. Body 8 is carried on four lifting members 10 which are actuated to raise and lower the body 8. Lifting members 10 may be in the form of electrically driven lead screws or hydraulic pistons, for example.

Positioned around the periphery of the main body is a plurality of pump chambers 12. Impeller pumps 16 are shown mounted in selected ones of the pump chambers 12, the pump impellers 18 being driven by electric motors 20 as well known in the art.

Main body conduits 22 extend through the main body 8. An inlet end 24 of each conduit 18 opens into a respective pump chamber 12 and the outlet end 26 of each conduit 22 is positioned in the upper surface 30 of the main body 8. Thus, solder is pumped by a pump 16 through a conduit 22 to the outlet opening 26 in the upper surface 30 of the main body 8.

A thimble plate 32 is mounted on the upper surface 30 of the main body 8. The thimble plate 32 may be secured in place by screws (not shown), for example.

Thimble plate 32 has a plurality of thimbles 34 mounted on its upper surface 36. A conduit 38 extends through the thimble plate 32 from a main conduit outlet 26 to the thimble inlet 40 which is positioned over the thimble conduit outlet 42. A seal 44 is provided between the main conduit outlet 26 and the thimble conduit inlet 46.

The thimbles 34 need not be positioned over the main conduit outlets 26. The thimble conduits 38 extend through the thimble body to the required location for the thimble. Thus, each thimble body is manufactured to suit the required locations of the thimbles 34.

When a thimble plate is to be replaced, the pumps 16 are lifted from the solder bath and the main body 6 is raised on lifting mechanisms 20 to bring the thimble plate 32 and the main body upper surface 30 clear of the solder 6 in the solder bath 4. The thimble plate 32 is then removed and a different plate fixed to the main body. The main body 8 is lowered into the bath and the pumps 16 placed in the appropriate pump chambers 12 in the main body 8.

The bearings for the pump impeller shaft are located immediately above the molten solder in the bath and so are exposed to considerable heat, which is undesirable. Also, the shear between the impeller shaft and the solder surface, where the shaft penetrates the surface gives rise to substantial accumulation of dust.

Shown in FIG. 3 is a nitrogen cooled pump bearing assembly in accordance with another aspect of the invention. The pump impellor shaft 50 is supported by a bearing assembly 52 which is contained within an outer housing 54. Nitrogen gas (which is generally fed to such soldering apparatus) is passed into the housing 54 and exits via outlet 56, and serves to provide cooling of the pump bearing assembly. This enables the pump bearing to be located close to the surface of the solder bath. A stationary seal housing 58 surrounds the impellor shaft 50 and is biased downwards by a spring 60. A polymer seal 62 is held in a cup 64 formed in the lower end of the seal housing and bears against a peripheral flange 66 on the impellor shaft 50. A layer of thermal insulation 70 is provided between the upper end 50A of the impellor shaft 50 and an outer sleeve 72 which is carried in rotary bearings 74. The impellor shaft 50 may be drilled out, i.e. hollow, to form an axial chamber 77 at its upper end and four radial throughways 75 provided extending through the sleeve 72, insulation 70 and the wall of the shaft 50, for cooling gas to pass into the hollow 70 at the upper end of the shaft. The shaft is rotated at its upper end by a drive belt driven by electric motor 20 and coupled to a pulley wheel 76 mounted on the upper end of the shaft 50. Four radial throughways 78 in the pulley 76 are aligned with the throughways 75 in the impeller shaft assembly to allow nitrogen gas to enter. Lower down the shaft 50, four radial arms 80 are formed and have throughways 81 to allow the nitrogen gas to exit chamber 77, thus providing for a flow of gas through the upper end of the shaft 50.

Where a rotating shaft penetrates the surface of the solder, there is an accumulation of dust or powder. This contaminates the solder. Thus we provide the stationary seal 58, 62 around the shaft 50 where it penetrates the solder surface so there is no relative movement or shear between the shaft 50 and the solder surface 82.

Referring to FIG. 4, the pump bearing assembly is similar to the assembly of FIG. 4 save that the stationary seal housing 58′ is allowed to float laterally in order to reduce wear between the shaft 50 and seal 62′. Seal 62′ extends axially along the shaft 50 for the height of the housing 58′ in the region of the shaft. Housing 58′ is stepped at its upper end to form a laterally extending lip 82 having apertures 84 which fit loosely over pins 86 fixed to the beating assembly housing lower wall 54. Housing 58′ extends through aperture 88 on the lower housing wall 54 with clearance to allow for lateral movement. The housing 58′ is thus secured against rotation but is allowed to float laterally, reducing wear between the shaft 50 and the polymer seal 62.

1. A soldering apparatus comprising a solder bath, a body positioned in the bath and having a plurality of main conduits, each main conduit having a first, inlet end for fluid communication with a pump chamber and a second, outlet end which is open at an upper surface of the main body, a thimble plate having upper and lower surfaces, a plurality of thimbles on the upper surface and a plurality of thimble plate conduits in the thimble plate, each thimble plate conduit having a first, inlet end which is open at a lower surface of the thimble plate for fluid communication with the outlet of a respective main conduit and a second, outlet end which is in fluid communication with a respective thimble.

2. A soldering apparatus as claimed in claim 1, wherein pump chambers are provided integral with the main body.

3. A soldering apparatus as claimed in claim 1, wherein means is provided for lifting the main body to raise the upper surface of the main body clear of solder in the bath.

4. A soldering apparatus as claimed in claim 1, wherein the conduits in the thimble plate are formed by channels in the plate lower surface, the channels being closed by the main body upper surface.

5. Selective soldering apparatus including a solder bath and a solder pump, the pump having an impellor shaft which, in use, extends through the surface of solder in the bath, the upper end of the shaft above the solder being carried in bearings, wherein the bearings and the upper end of the shaft are mounted in a housing and a supply of nitrogen gas is provided and fed to the housing to cool the bearing assembly.

6. An apparatus as claimed in claim 5, wherein a passageway for the nitrogen gas is provided in the upper end of the impellor shaft.

7. A pump as claimed in claim 5, wherein the upper end of the impellor shaft is carried in a rotary bearing and a layer of thermal insulation is provided between the impellor shaft and the bearing.

8. A pump as claimed in claim 5, wherein a non-rotating seal is provided around the impellor shaft where the shaft extends thorough the surface of solder in the solder bath.

9. A pump as claimed in claim 8, wherein means is provided to support the seal, the supporting means preventing substantial rotary movement of the seal but allowing lateral movement of the seal.

10. A pump as claimed in claim 8, wherein the seal comprises a housing and a polymer bearing supported in the housing and forming a seal against the impellor shaft.

11. Selective a soldering apparatus comprising a solder bath and a solder pump having a shaft which extends, in use, though the surface of solder in the solder bath, wherein a non-rotating seal is provided around the impellor shaft where the shaft extends thorough the surface of solder in the solder bath.

12. A soldering apparatus as claimed in claim 2, wherein means is provided for lifting the main body to raise the upper surface of the main body clear of solder in the bath.

13. A soldering apparatus as claimed in claim 2, wherein the conduits in the thimble plate are formed by channels in the plate lower surface, the channels being closed by the main body upper surface.

14. A soldering apparatus as claimed in claim 3, wherein the conduits in the thimble plate are formed by channels in the plate lower surface, the channels being closed by the main body upper surface.

15. A pump as claimed in claim 6, wherein the upper end of the impellor shaft is carried in a rotary bearing and a layer of thermal insulation is provided between the impellor shaft and the bearing.

16. A pump as claimed in claim 6, wherein a non-rotating seal is provided around the impellor shaft where the shaft extends thorough the surface of solder in the solder bath.

17. A pump as claimed in claim 7, wherein a non-rotating seal is provided around the impellor shaft where the shaft extends thorough the surface of solder in the solder bath.

18. A pump as claimed in claim 9, wherein the seal comprises a housing and a polymer bearing supported in the housing and forming a seal against the impellor shaft.
